(19) United States
(12) Patent Application Publication
(10) Pub. No.: US 2018/0151290 A1
(43) Pub. Date: May 31, 2018

(54) INTEGRATED INDUCTOR AND METHOD FOR MANUFACTURING THE SAME

(71) Applicant: Realtek Semiconductor Corporation, Hsinchu (TW)

(72) Inventors: Hsiao-Tsung YEN, Hsinchu City (TW); Yuh-Sheng Jean, Hsinchu County (TW); Ta-Hsun Yeh, Hsinchu City (TW)

(21) Appl. No.: 15/818,778

(22) Filed: Nov. 21, 2017

(30) Foreign Application Priority Data
Nov. 25, 2016 (TW) 105138910

(51) Int. Cl. H01F 27/36; H01F 27/28; H01F 27/29; H01F 27/32; H01F 41/04; H01F 41/12

(52) U.S. Cl. CPC H01F 27/36; H01F 27/2804; H01F 41/12; H01F 27/32; H01F 41/041; H01F 27/29

(57) ABSTRACT

An integrated inductor is disclosed herein. The integrated inductor includes a substrate, an insulation layer, and an inductor. The substrate includes a trench. At least a portion of the insulation layer is formed in the trench. The inductor is disposed in the trench, and the inductor is disposed on the insulation layer.

### RELATED APPLICATIONS

This application claims priority to Taiwan Application Serial Number 105138910, filed Nov. 25, 2016, which is herein incorporated by reference.

### BACKGROUND

### Field of Invention

The present disclosure relates to a basic electronic circuit. More particularly, the present disclosure relates to an inductor structure and a method for manufacturing the same.

### Description of Related Art

Conventional inductors occupy large area in a chip, and are easy to have EMI radiation issue. Therefore, 8-shaped inductors arise at an opportune time due to its low EMI radiation possibility and its structure property for neutralizing coupling, such that 8-shaped inductors usually have low mutual coupling value.

However, with miniaturization of electronic products, the 8-shaped inductors still occupy some area in the chip, which is harmful to miniaturization of electronic products. In addition, compared to the conventional inductors, the quality factor of the 8-shaped inductor is lower.

In view of the foregoing, problems and disadvantages are associated with existing products that require further improvement. However, those skilled in the art have yet to find a solution.

### SUMMARY

The following presents a simplified summary of the disclosure in order to provide a basic understanding to the reader. This summary is not an extensive overview of the disclosure and it does not identify key/critical elements of the present disclosure or delineate the scope of the present disclosure.

One aspect of the present disclosure is directed to an inductor structure. The integrated inductor includes a substrate, an insulation layer, and an inductor. The substrate includes a trench. At least a portion of the insulation layer is formed in the trench. The inductor is disposed in the trench and on the insulation layer.

Another aspect of the present disclosure is directed to a method for manufacturing an integrated inductor. The method includes steps as following: forming a trench in a substrate; forming at least a portion of an insulation layer in the trench; and disposing an inductor in the trench and on the insulation layer.

In view of the foregoing, embodiments of the present disclosure provide an integrated inductor and a method for manufacturing the same to improve the problems related to 8-shaped inductors occupying area in a chip which is harmful to miniaturization of electronic products, and related also to quality factor of the 8-shaped inductors being lower. Since the inductor of the present disclosure is disposed in the trench of the substrate, the substrate is able to block EMI radiation, such that the quality factor of the 8-shaped inductors can be improved and the ability for blocking EMI radiation can be remained. In addition, patterned ground shields (PGS) can be placed in inter-metals which are disposed above the metal layers of the trenches of the substrate to enhance insulation ability for coupling. Other wires may be placed above the PGS.

These and other features, aspects, and advantages of the present disclosure, as well as the technical means and embodiments employed by the present disclosure, will become better understood with reference to the following description in connection with the accompanying drawings and appended claims.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an inductor structure according to embodiments of the present disclosure;

FIG. 2 is a sectional view of the inductor structure as illustrated in FIG. 1 according to embodiments of the present disclosure;

FIG. 3 is a schematic diagram of an inductor structure according to embodiments of the present disclosure;

FIG. 4 is a sectional view of the inductor structure as illustrated in FIG. 3 according to embodiments of the present disclosure;

FIG. 5 is a top view of an inductor structure according to embodiments of the present disclosure;

FIG. 6 is a top view of an inductor structure according to embodiments of the present disclosure; and

FIG. 7 is a top view of an inductor structure according to embodiments of the present disclosure.

In accordance with common practice, the various described features/elements are not drawn to scale but instead are drawn to best illustrate specific features/elements relevant to the present disclosure. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

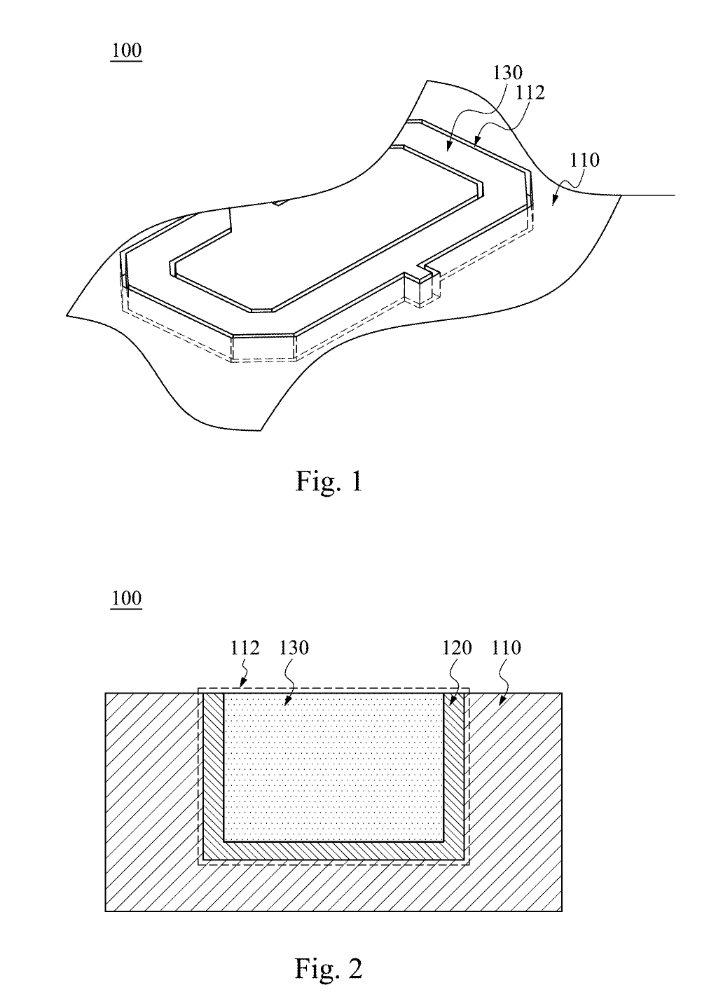

FIG. 1 is a schematic diagram of an inductor structure 100 according to embodiments of the present disclosure. FIG. 2 is a sectional view of the inductor structure 100 as illustrated in FIG. 1 according to embodiments of the present disclosure. Referring to both FIG. 1 and FIG. 2, the integrated inductor 100 includes a substrate 110, an insulation layer 120 and an inductor 130. In addition, the substrate 110 includes a trench 112. Reference is now made to FIG. 2, at least a portion of the insulation layer 120 is formed in the trench 112. The inductor 130 is disposed in the trench 112 and on the insulation layer 120. It is noted that the integrated inductor 100 in FIG. 2 is a complete structure after the manufacturing process. During the manufacturing process, the trench 112 is firstly formed in the substrate 110; subsequently, the insulation layer 120 is formed on the trench 112, and the inductor 130 is disposed on the insulation layer 120 and within the trench 112.

In view of the above, since the inductor 130 of the integrated inductor 100 is disposed in the trench 112 of the substrate 110, the volume of the integrated inductor 100 can be reduced. In addition, since the inductor 130 is disposed in the trench 112, the EMI radiation generated by the inductor 130 during operating can be blocked.

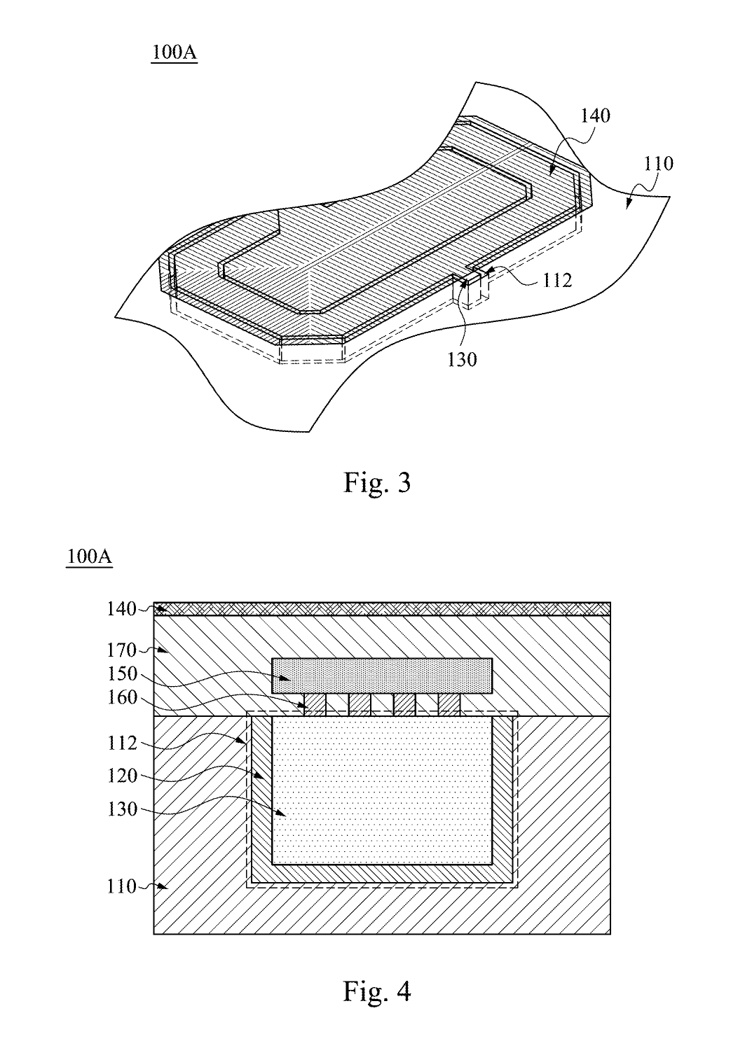

FIG. 3 is a schematic diagram of an inductor structure 100A according to embodiments of the present disclosure. Compared with the integrated inductor 100 as shown in FIG. 1, the integrated inductor 100A in FIG. 3 further includes a patterned ground shield 140, and the patterned ground shield 140 is disposed above the substrate 110 and the inductor 130. With respect to structure, the patterned ground shield 140 is disposed above the inductor 130; therefore, the electromagnetic radiation generated by the inductor 130 during operation can be further blocked. In one embodiment, the patterned ground shield 140 can be coupled to ground so that it is called patterned ground shield (PGS). In addition, the patterned ground shield 140 can also be disposed in a floating manner.

FIG. 4 is a sectional view of the inductor structure 100A as illustrated in FIG. 3 according to embodiments of the present disclosure. As illustrated by the structure in FIG. 4, the structure of the integrated inductor 100A in FIG. 3 can be understood easily. As shown in the figure, the patterned ground shield 140 is disposed above the inductor 130. In addition, metal layers (i.e., the metal layer 150) can be stacked above the inductor 130. For example, the metal layer 150 is disposed between the patterned ground shield 140 and the inductor 130, and the metal layer 150 is coupled to the inductor 130 through a plurality of connection portions (via) 160. In one embodiment, the integrated inductor 100A further includes a dielectric layer 170. The dielectric layer 170 is disposed between the patterned ground shield 140 and the inductor 130, and covers the metal layer 150 and the connection portions 160.

In another embodiment, the inductors 130 of the integrated inductors 100, 100A as shown in FIG. 1 to FIG. 4 can be 8-shaped inductors, and the trench 112 of the substrate 110 of the integrated inductors 100, 100A can be 8-shaped trenches correspondingly. Although FIG. 1 to FIG. 3 merely illustrates a portion of the 8-shaped inductors, those skilled in the art may understand that the 8-shaped inductors can be disposed in the 8-shaped trenches correspondingly. As shown in FIG. 4, although the quality factor of the 8-shaped inductor is lower than that of the conventional inductor, the quality factor of the 8-shaped inductor can be enhanced by stacking metal layers above the inductor 130 to control the inductor 130 through the stacked metal layers. The thickness of the inductor 130 in the substrate trench 112 is larger than the thickness of the metal layer above the substrate, and the thickness can be about 20 um-100 um.

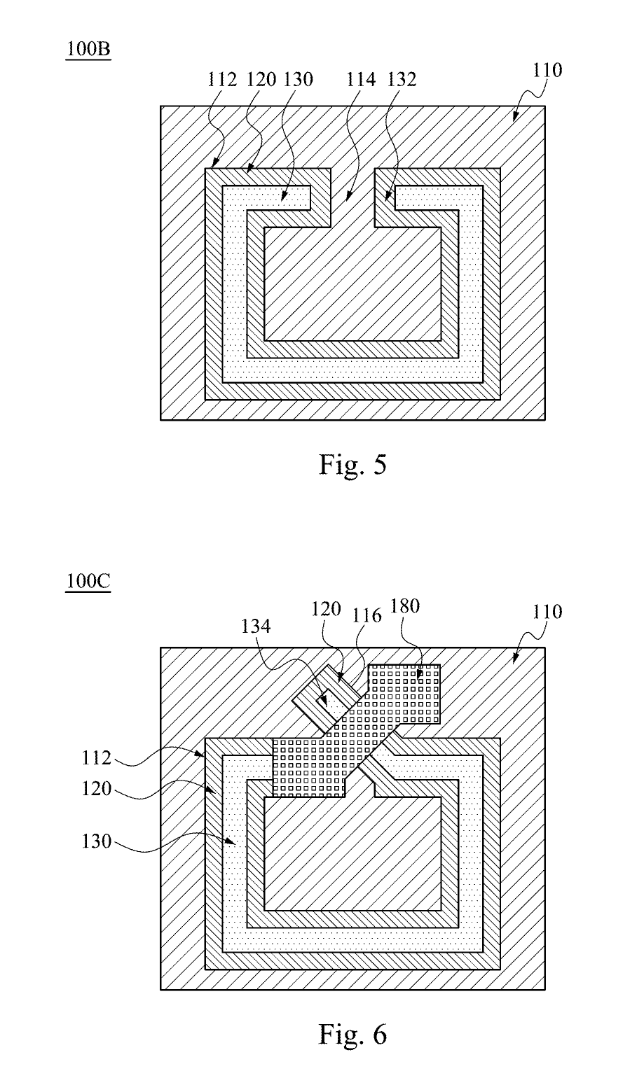

FIG. 5 is a top view of an inductor structure 100B according to embodiments of the present disclosure. In this embodiment, the trench 112 of the integrated inductor 100B includes a first annular trench. An insulation layer 120 is formed on the first annular trench 112. In addition, the inductor 130 comprises a first annular inductor. The first annular inductor 130 is disposed in the first annular trench 112, and disposed above the insulation layer 120. In another embodiment, the first annular trench 112 includes a first opening 114, and the first annular inductor 130 includes a second opening 132. The second opening 132 and the first opening 114 are disposed correspondingly. For example, the first annular trench 112 includes a portion that is not penetrated through. In this top view, the non-penetrated portion looks like the opening of the first annular trench 112; therefore, it is called the first opening 114. Besides, the first annular inductor 130 also includes a second opening 132, and the above-mentioned openings 114, 132 are disposed correspondingly.

FIG. 6 is a top view of an inductor structure 100C according to embodiments of the present disclosure. Compared with the integrated inductor 100B in FIG. 5, the first annular trench 112 of the integrated inductor 100C in FIG. 6 further includes a trench branch 116. The insulation layer 120 is formed on the trench branch 116. In addition, the first annular inductor 130 further includes an inductor branch 134. The inductor branch 134 is disposed in the trench branch 116 and on the insulation layer 120. In one embodiment, the integrated inductor 100C further includes a branch portion 180. The branch portion 180 and the inductor branch 134 are disposed in an interlaced manner.

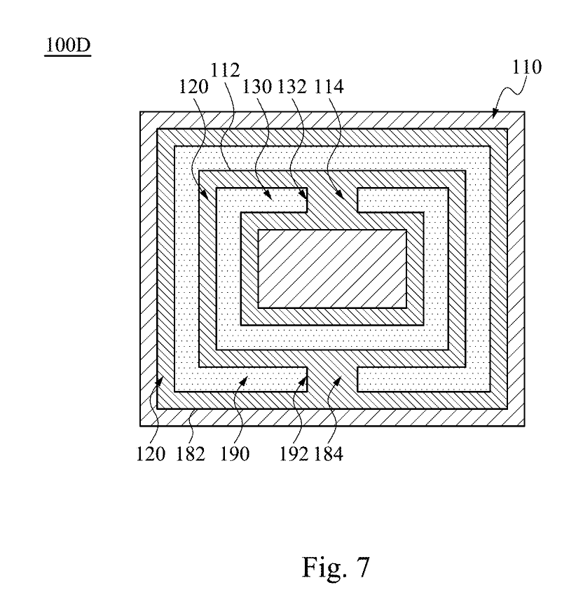

FIG. 7 is a top view of an inductor structure 100D according to embodiments of the present disclosure. Compared with the integrated inductor 100C as shown in FIG. 6, the integrated inductor 100D in FIG. 7 further includes a second annular trench 182. The second annular trench 182 is disposed outside the first annular trench 112. In addition, the integrated inductor 100D further includes a second annular inductor 190. The second annular inductor 190 is disposed inside the second annular trench 182. In one embodiment, the second annular trench 182 includes a third opening 184, and the second annular inductor 190 includes a fourth opening 192. The fourth opening 192 and the third opening 184 are disposed correspondingly. In another embodiment, the second opening 132 of the first annular inductor 130 is located at one side of the integrated inductor 100D (as shown in the upper side of the figure), and the fourth opening 192 of the second annular inductor 190 is located at another side of the integrated inductor 100D (as shown in the lower side of the figure).

In another aspect of the present disclosure, a method for manufacturing an integrated inductor of the present disclosure includes the following steps:

step 210: forming a trench in a substrate;

step 220: forming at least a portion of an insulation layer in the trench; and

step 230: disposing an inductor in the trench and on the insulation layer.

For facilitating the understanding of the method for manufacturing the integrated inductor of the present disclosure, reference is now made to FIG. 2. In step 210, the trench 112 is formed in the substrate 110. In step 220, the at least a portion of the insulation layer 120 is formed in the trench 110. In step 230, the inductor 130 is disposed in the trench 112 and on the insulation layer 120.

For facilitating the understanding of the method for manufacturing the integrated inductor of the present disclosure, reference is now made to FIGS. 3, 4. In one embodiment, the method for manufacturing the integrated inductor of the present disclosure further includes the following step: disposing a patterned ground shield 140 above the substrate 110 and the inductor 130. In another embodiment, the method for manufacturing the integrated inductor of the present disclosure further includes the following steps: disposing a metal layer 150 between the patterned ground shield 140 and the inductor 130; and coupling the metal layer 150 and the inductor 130 by a plurality of connection portions 160.

In still another embodiment, the method for manufacturing the integrated inductor of the present disclosure further includes the following steps: forming a dielectric layer 170 between the patterned ground shield 140 and the inductor 130, and covering the metal layer 150 and the connection portions 160.

For facilitating the understanding of the method for manufacturing the integrated inductor of the present disclosure, reference is now made to FIG. 5. In one embodiment, step 210 includes: the first annular trench 112 is formed in the substrate 110. In addition, step 230 includes: disposing the first annular inductor 130 in the first annular trench 112. In another embodiment, the first annular trench 112 includes a first opening 114, and the first annular inductor 130 includes a second opening 132. The second opening 132 and the first opening 114 are disposed correspondingly.

For facilitating the understanding of the method for manufacturing the integrated inductor of the present disclosure, reference is now made to FIG. 6. The first annular trench 112 further includes a trench branch 116, and the first annular inductor 130 further includes an inductor branch 134. The inductor branch 134 is disposed in the trench branch 116.

In another embodiment, for facilitating the understanding of the method for manufacturing the integrated inductor of the present disclosure, reference is now made to FIG. 7. The method for manufacturing the integrated inductor of the present disclosure further includes the following steps: disposing a second annular trench 182 outside the first annular trench 112; and disposing the second annular inductor 190 inside the second annular trench 182. In still another embodiment, the second annular trench 182 includes a third opening 184, and the second annular inductor 190 includes a fourth opening 192. The fourth opening 192 and the third opening 184 are disposed correspondingly. In yet another embodiment, the second opening 132 of the first annular inductor 130 is located at one side of the integrated inductor 100D (as shown in the upper side of the figure), and the fourth opening 192 of the second annular inductor 190 is located at another side of integrated inductor 100D (as shown in the lower side of the figure).

In view of the above embodiments of the present disclosure, it is apparent that the application of the present disclosure has the advantages as follows. Embodiments of the present disclosure provide an integrated inductor and a method for manufacturing the same to improve the problems related to 8-shaped inductors occupying area in a chip which is harmful to miniaturization of electronic products, and related also to quality factor of the 8-shaped inductors being lower.

Since inductors of the present disclosure are disposed in trenches of a substrate, the substrate is able to block EMI radiation, such that the quality factor of the 8-shaped inductors can be improved and the ability for blocking EMI radiation can be remained. In addition, patterned ground shields (PGS) can be placed in inter-metals which are disposed above the metal layers of trenches of the substrate to enhance insulation ability for coupling. Other wires may be placed above the PGS.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An integrated inductor, comprising:
a substrate comprising:
a trench;
an insulation layer, wherein at least a portion of the insulation layer is formed in the trench; and
an inductor disposed in the trench and on the insulation layer.

2. The integrated inductor of claim 1, further comprising:
a patterned ground shield disposed above the substrate and the inductor.

3. The integrated inductor of claim 2, further comprising:
a metal layer disposed between the patterned ground shield and the inductor; and
a plurality of connection portions coupled to the metal layer and the inductor.

4. The integrated inductor of claim 3, further comprising:
a dielectric layer disposed between the patterned ground shield and the inductor, and covering the metal layer and the connection portions.

5. The integrated inductor of claim 1, wherein the trench comprises a first annular trench, and the inductor comprises a first annular inductor, wherein the first annular inductor is disposed in the first annular trench.

6. The integrated inductor of claim 5, wherein the first annular trench comprises a first opening, and the first annular inductor comprises a second opening, wherein the second opening and the first opening is disposed correspondingly.

7. The integrated inductor of claim 6, wherein the first annular trench comprises a trench branch, and the first annular inductor comprises an inductor branch, wherein the inductor branch is disposed in the trench branch.

8. The integrated inductor of claim 6, further comprising:
a second annular trench disposed outside the first annular trench; and
a second annular inductor disposed inside the second annular trench.

9. The integrated inductor of claim 8, wherein the second annular trench comprises a third opening, and the second annular inductor comprises a fourth opening, wherein the fourth opening and the third opening is disposed correspondingly.

10. The integrated inductor of claim 9, wherein the second opening of the first annular inductor is located at one side of an integrated inductor, and the fourth opening of the second annular inductor is located at another side of the integrated inductor.

11. A method for manufacturing an integrated inductor, comprising:
forming a trench in a substrate;
forming at least a portion of an insulation layer in the trench; and
disposing an inductor in the trench and on the insulation layer.

12. The method of claim 11, further comprising:
disposing a patterned ground shield above the substrate and the inductor.

13. The method of claim 12, further comprising:
disposing a metal layer between the patterned ground shield and the inductor; and
coupling the metal layer and the inductor by a plurality of connection portions.

14. The method of claim 13, further comprising:
forming a dielectric layer between the patterned ground shield and the inductor, and covering the metal layer and the connection portions.

15. The method of claim 11, wherein forming the trench in the substrate comprises:
forming a first annular trench in the substrate;
wherein disposing the inductor in the trench comprises:
disposing a first annular inductor in the first annular trench.

16. The method of claim 15, wherein the first annular trench comprises a first opening, and the first annular inductor comprises a second opening, wherein the second opening and the first opening are disposed correspondingly.

17. The method of claim 16, wherein the first annular trench comprises a trench branch, and the first annular inductor comprises an inductor branch, wherein the inductor branch is disposed in the trench branch.

18. The method of claim 16, further comprising:
disposing a second annular trench outside the first annular trench; and
disposing a second annular inductor inside the second annular trench.

19. The method of claim 18, wherein the second annular trench comprises a third opening, and the second annular inductor comprises a fourth opening, wherein the fourth opening and the third opening are disposed correspondingly.

20. The method of claim 19, wherein the second opening of the first annular inductor is located at one side of an integrated inductor, and the fourth opening of the second annular inductor is located at another side of the integrated inductor.
